(19) United States
(12) Patent Application Publication
(10) Pub. No.: US 2010/0187803 A1
(43) Pub. Date: Jul. 29, 2010

(54) COVER CAPABLE OF SUPPORTING DIARY OR CALENDAR

(76) Inventor: Jeong Woo Park, Cheonan-si (KR)

Correspondence Address: CHRISTOPHER PAUL MITCHELL, 888 16TH ST., NW, SUITE 800, WASHINGTON, DC, 20006, US

(21) Appl. No.: 12/668,637

(22) PCT Filed: Jul. 9, 2008
(86) PCT No.: PCT/KR08/04047

§ 371 Date: Jan. 11, 2010

(30) Foreign Application Priority Data
Jul. 9, 2007 (KR) 10-2007-0068554
Jul. 16, 2007 (KR) 10-2007-0071102
May 23, 2008 (KR) 10-2008-0047826

(51) Int. Cl. B42D 3/00

(52) U.S. Cl. 281/33

(57) ABSTRACT

A cover, which is capable of supporting multi-purpose contents and of improving portability and utility, is disclosed. The cover capable of supporting multi-purpose contents includes a front cover and a back cover which are superposed on front and back surfaces of a page unit and are bound by a binder. The front cover includes a main front cover part and a subsidiary front cover part which are separated from each other by a separation line, and an angle holding unit is provided between the main front cover part and the subsidiary front cover part to maintain an angle between the main front cover part and the subsidiary front cover part. Further, a position holding unit may be provided between the front cover and the back cover to hold the front and back covers in a folded or erected position.

### TECHNICAL FIELD

The present invention relates, in general, to a cover capable of supporting multi-purpose contents, which is applicable to various types of products and, more particularly, to a cover capable of supporting multi-purpose contents, which has improved portability and utility.

### BACKGROUND ART

A product, including pages containing written matter and covers enclosing the pages on both sides, for example, a book, a notebook, a memo pad, an album, a picture book, a business-card arranger, a diary, a calendar, a catalogue of an insurance company or bank, and an electronic note, must be placed on a table in order to be used it or write on the pages. In this state, a user pulls his or her body forward and bows his or her head.

However, the posture of pulling the body towards the table and bowing one's head is a burden on the user's waist and eyes. Thus, when the posture is repeated for a lengthy period of time, a spinal disease, amblyopia, empyema, and the lowering of learning efficiency may ensue.

### DISCLOSURE OF INVENTION

### Technical Problem

Accordingly, the present invention has been made keeping in mind the above problems occurring in the prior art, and an object of the present invention is to provide a cover capable of supporting multi-purpose contents, which can be used without bending the waist or head, thus maximizing convenient use thereof, in addition to improving the portability.

### Technical Solution

In order to accomplish the above object, the present invention provides a cover capable of supporting multi-purpose contents, which has a front cover and a back cover which are superposed on front and back surfaces of a page unit and are bound by a binder, wherein the front cover includes a main front cover part and a subsidiary front cover part which are separated from each other by a separation line, and an angle holding unit is provided between the main front cover part and the subsidiary front cover part to maintain an angle between the main front cover part and the subsidiary front cover part.

The above and other features and advantages of the present invention will be more clearly understood from the following detailed description taken in conjunction with the accompanying drawings. Here, the terminologies or words used in the description and the claims of the present invention should not be interpreted as being limited merely to common and dictionary meanings, but should be interpreted based on the meanings and concepts of the invention in keeping with the scope of the invention on the basis of the principle that the inventor can appropriately define the terms in order to describe the invention in the best way.

### Advantageous Effects

A cover capable of supporting multi-purpose contents according to the present invention is advantageous in that it includes a front cover having main and subsidiary front cover parts which are separated from each other by a separation line, and an angle holding unit provided between the main and subsidiary front cover parts to hold an angle between the main and subsidiary front cover parts, thus easily maintaining the erected or collapsed state of the front and back covers, so that the multipurpose over support can be used without bending the waist or head, and so that utility and portability are improved.

### BRIEF DESCRIPTION OF THE DRAWINGS

FIG. 1 is a view illustrating a cover capable of supporting multi-purpose contents according to the first embodiment of the present invention;

FIG. 2 is a view illustrating a position holding unit which is installed on the front and back covers;

FIG. 3 is a view illustrating the state in which the front and back covers are erected by the position holding unit of FIG. 2;

FIG. 4 is a view illustrating the operation of unfolding the front cover relative to the back cover such that the front cover is at an obtuse angle with the back cover;

FIG. 5 is view illustrating an angle holding unit for holding the unfolded front cover supported at an angle;

FIG. 6 is a view illustrating another embodiment of the angle holding unit of FIG. 5;

FIG. 7 is a view illustrating a picture mounting part formed in the front cover;

FIG. 8 is a view illustrating another embodiment of the picture mounting part of FIG. 7;

FIG. 9 is a view illustrating a further embodiment of the picture mounting part of FIG. 7;

FIG. 10 is a view illustrating a binder which directly connects the front and back covers to each other;

FIG. 11 is a view illustrating an embodiment of a page mounting part which mounts pages;

FIGS. 12 and 13 are views illustrating another embodiment of the page mounting part whereby pages are mounted;

FIG. 14 is a view illustrating a back cover having a main back cover part and a subsidiary back cover part;

FIG. 15 is a view illustrating the operation of unfolding the front cover of FIG. 14 relative to the back cover such that the front cover is at an obtuse angle with the back cover;

FIG. 16 is a view illustrating the state in which the front and back covers of FIG. 15 are erected;

FIG. 17 is a view illustrating a back cover having a main back cover part and a subsidiary back cover part;

FIG. 18 is a view illustrating the state in which the back cover of FIG. 17 is rotated outwards to be erected;

FIG. 19 is a view illustrating a cover capable of supporting multi-purpose contents according to the second embodiment of the present invention; and

FIG. 20 is a view illustrating the state in which the front and back covers of FIG. 19 are in an erected state.

### DESCRIPTION OF REFERENCE CHARACTERS OF IMPORTANT PARTS

110: binder 120: page unit 120a: fastening holes

121: subsidiary fastening rings 130: front cover

130a: separation line 131: main front cover part

131a: stepped surface 131b: protrusion insert holes

132: subsidiary front cover part

136: detachable attaching unit 136a: magnet

136b: steel piece 140: back cover

141: main back cover part 141a: stepped surface

142: subsidiary back cover part 143: back cover

143a: main back cover part

143b: subsidiary back cover part

144: subsidiary angle holding unit

145: subsidiary detachable attaching unit

146: detachable attaching unit 146a: magnet

146b: steel piece 150: angle holding unit

155: angle holding unit 155b: support protrusion

156: angle holding unit 156a: plate

156b: support protrusion 160: position holding unit

161: band member 162: first detachable attaching part

163: second detachable attaching part

164: third detachable attaching part

165: fourth detachable attaching part

171, 172, 173, 174, 175: picture mounting part

171a, 172a, 173a, 174a: window

171b, 172b, 173b, 174b: picture entrance slit

175a: picture entrance opening 175b: window

175c, 175d: magnetic detachable attaching unit

181: page mounting part 181a: mounting body

181b: fastening rings 183: page mounting part

183a: fitting holes 183b: support strip

210: binder 220: page unit 230: front cover

231: main front cover part

232: subsidiary front cover part

240: back cover 250: angle holding unit

261, 262: first, second detachable attaching part

### MODE FOR THE INVENTION

The above and other objects, features and advantages of the present invention will be more clearly understood from the following detailed description.

Hereinafter, a cover capable of supporting multi-purpose contents according to the present invention will be described with reference to the accompanying drawings.

Reference now should be made to the drawings, in which the same reference numerals are used throughout the different drawings to designate the same or similar components. For the clarity of description, known functions and constructions relating to the present invention will be omitted herein.

Hereinafter, the construction and effects of the preferred embodiments for accomplishing the object of the present invention will be described with reference to the accompanying drawings.

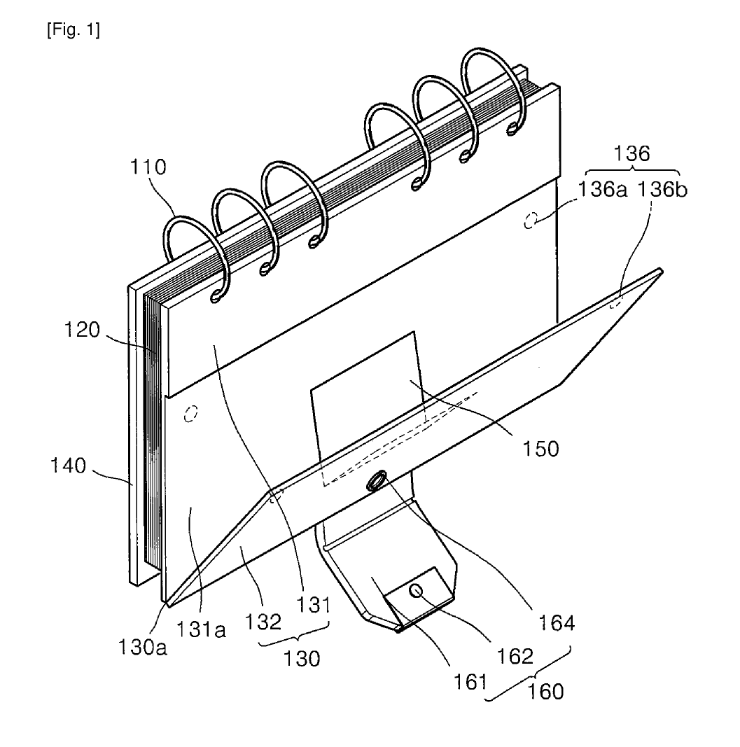

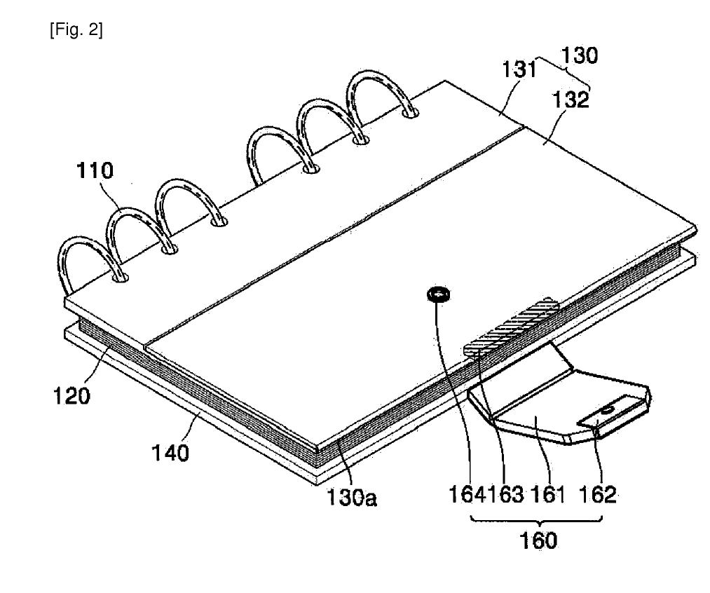

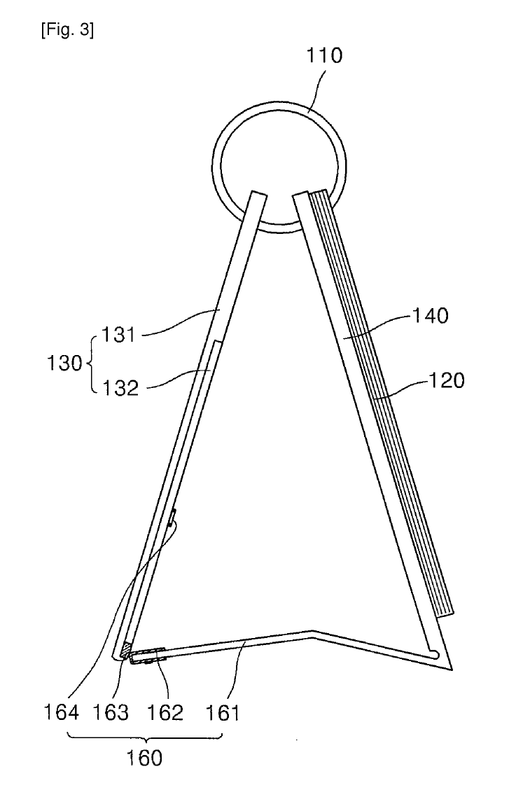

FIG. 1 is a view illustrating a cover capable of supporting multi-purpose contents according to the first embodiment of the present invention, FIG. 2 is a view illustrating a position holding unit which is installed on the front and back covers, and FIG. 3 is a view illustrating the state in which the front and back covers are erected by the position holding unit of FIG. 2.

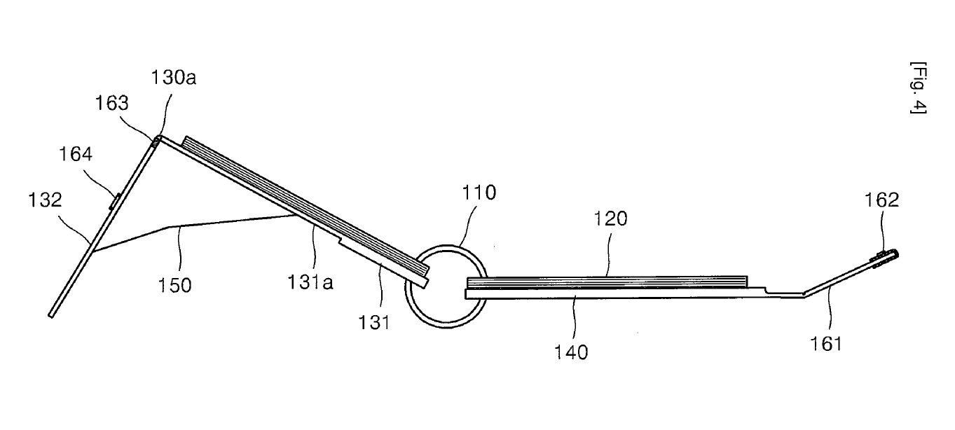

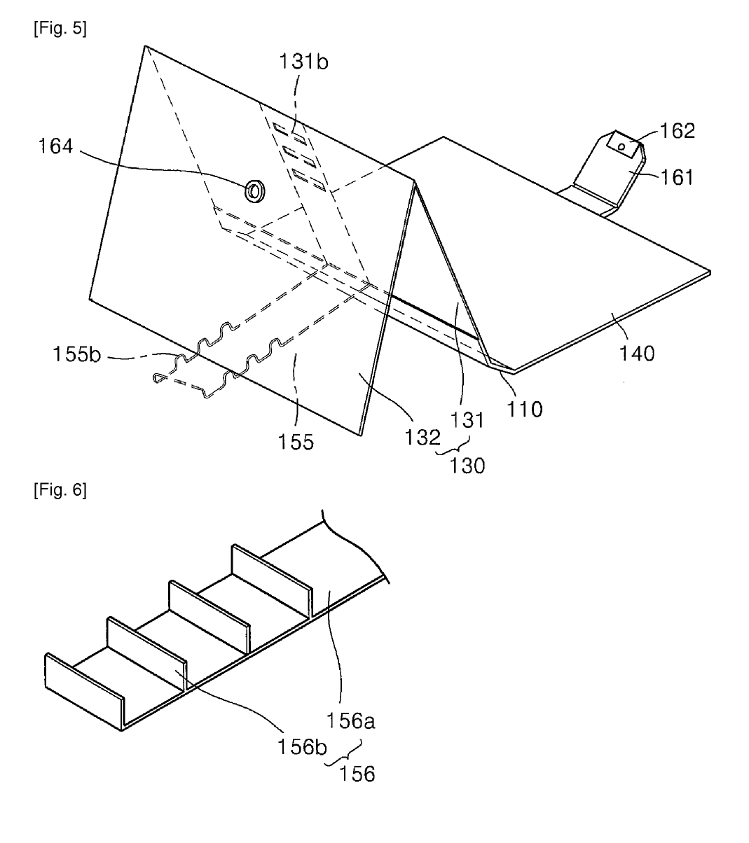

FIG. 4 is a view illustrating the operation of unfolding the front cover relative to the back cover such that the front cover is at an obtuse angle with the back cover, FIG. 5 is view illustrating an angle holding unit for holding the unfolded front cover supported at an angle, and FIG. 6 is a view illustrating another embodiment of the angle holding unit of FIG. 5.

As shown in the drawings, the cover capable of supporting multi-purpose contents according to the first embodiment of the present invention includes a front cover 130 and a back cover 140 which are superposed on the front and back surfaces of a page unit 120 and are connected by a binder 110. Here, the front cover 130 includes a main front cover part 131 and a subsidiary front cover part 132 which are separated from each other by a separation line 130a. An angle holding unit 150 is connected to the main front cover part 131 and the subsidiary front cover part 132 to create an angle between the main and subsidiary front cover parts 131 and 132. Further, a position holding unit 160 may be connected to an edge of the front cover 130 and an edge of the back cover 140 to maintain the erected or collapsed state of the front and back covers 130 and 140.

As shown in the drawings, the subsidiary front cover part 132 is connected to an edge of the main front cover part 131 via the separation line 130a. Of course, the subsidiary front cover part 132 may be provided under an edge of the main front cover part 131.

The binder 110 serves to connect the front and back covers 130 and 140 to each other, and may have various shapes. For example, the binder 110 may comprise a plurality of rings which pass through fastening holes formed in the upper portions of the front cover 130, the page unit 120, and the back cover 140 which overlap with each other. Further, as will be described later, the upper portions of the front cover 130 and the back cover 140 may be directly connected to each other by a separation line. Furthermore, the front cover 130 and the back cover 140 may be directly connected to each other in a curved shape without the separation line.

The page unit 120 may be embodied in various shapes. For example, the page unit 120 may comprise many pieces of paper on which pictures are printed, many pieces of paper showing the weeks or months of the year, or many pieces of paper containing notices of various situations, which frequently occur in an office, for example, ‘now in conference’, ‘being out’, or ‘now on business’. Further, the page unit may comprise many pieces of paper on which notes can be taken, or many pieces of paper on which telephone numbers or addresses can be recorded. Further, the page unit may comprise album pages for inserting photographs, pictures, and such, or many pieces of paper on which maps or religious sayings are printed.

In the front cover 130, a stepped surface 131a, which is thinner than the main front cover part 131, is horizontally provided on a predetermined portion of the main front cover part 131. The subsidiary front cover part 132 fits inside the stepped surface 131a and is folded at the separation line 130a. Here, the stepped surface 131a is thinner than the main front cover part 131. Thus, when the subsidiary front cover part 132 fits inside the stepped surface 131a, it is on a level with the main front cover part 131.

As shown in FIG. 1, a detachable attaching unit 136 is provided on the main front cover part 131 and the subsidiary front cover part 132 to maintain a closed state of the main front cover part 131 and the subsidiary front cover part 132. The detachable attaching unit 136 may comprise magnets which may be detachably attached to each other, or comprise a magnet and a steel piece. According to this embodiment, the detachable attaching unit includes a magnet 136a which is mounted to the main front cover part 131, and a steel piece 136b which is mounted to the subsidiary front cover part 132 and which will form an attachment with the magnet 136a. Of course, the detachable attaching unit 136 may comprise Velcro fasteners which may be detachably fastened to each other, or comprise buttons.

The angle holding unit 150 connects the main front cover part and the subsidiary front cover part to each other so as to maintain the angle between the main and subsidiary front cover parts 131 and 132, and may be embodied variously.

As shown in FIGS. 1 to 4, the angle holding unit 150 according to an embodiment may comprise a foldable band made of cloth or paper. Such an angle holding unit 150 may be attached to a surface of the subsidiary front cover part and a surface of the main front cover part or the stepped surface through thermal adhesion or ultrasonic adhesion. Here, the angle holding unit 150 may comprise a sheet which has the same width as the subsidiary front cover part or the main front cover part. Of course, the angle holding unit 150 may comprise two or more bands, and may be installed at different positions.

According to another embodiment, as shown in FIG. 5, an angle holding unit 155 includes a plurality of support protrusions 155b, which are foldably connected to the lower edge of the front cover 130. When the front cover 130 is opened, an edge of the subsidiary front cover part 132 is supported by an associated support protrusion. Further, when the front cover 130 is closed, the support protrusions are fitted into corresponding protrusion insert holes 131b of the main front cover part 131. Such an angle holding unit 155 may be manufactured using various materials, for example by bending wire. Here, an edge of the subsidiary front cover part 132 is supported by an associated support protrusion 155b. Further, when the angle holding unit 155 is rotated to overlap the main front cover part 131, the support protrusions 155b are fitted into the corresponding protrusion insert holes 131b.

According to a further embodiment, as shown in FIG. 6, an angle holding unit 156 includes a rectangular plate 156a, and supporting pieces 156 which protrude upwards from the plate and are spaced apart from each other at a predetermined interval. Here, the angle holding unit 156 may be manufactured by welding support protrusions 156b to the metallic plate 156a, or may be manufactured such that the plate 156a and the support protrusions 156b are integrated with each other using plastic or resin. An edge of the subsidiary front cover part 132 is supported by an associated support protrusion 156b of the angle holding unit 156. Further, when the angle holding unit 156 is folded to lie against the back surface of the main front cover part 131, the support protrusions 156b are fitted into the corresponding protrusion insert holes 131b.

Meanwhile, the position holding unit 160 functions to maintain the erected or collapsed state of the front and back covers 130 and 140.

According to this embodiment, as shown in FIG. 2, the position holding unit 160 includes a band member 161 which is provided on either of the front and back covers 130 and 140, a first detachable attaching part 162 which is provided at an end of the band member 161, a second detachable attaching part 163 which is provided on the other remaining one of the front and back covers 130 and 140 and is detachably attached to the first detachable attaching part 162, and a third detachable attaching part 164 which is provided above the second detachable attaching part 163 and is detachably attached to the first detachable attaching part 162. According to this embodiment, the band member 161 is installed at an edge of the back cover 140, the first detachable attaching part 162 is installed at an edge of the band member 161, the second detachable attaching part 163 is installed at a position around the separation line 130a on the inner surface of the main front cover part 131, and the third detachable attaching part 164 is installed on an upper portion of the subsidiary front cover part 132.

The first detachable attaching part 162 and the second or third detachable attaching part 163 or 164 may comprise Velcro fasteners so that they are detachably attached to each other, or comprise a magnet and a steel piece which are detachably attached to each other using magnetic force, or comprise magnets which are arranged such that opposite poles face each other. Further, the first detachable attaching part 162 may be embedded in the band member 161 such that the first detachable attaching part is not seen from the exterior. The second or third detachable attaching part 163 or 164 may be embedded in an edge of the front cover or the back cover such that the second or third detachable attaching part is not seen from the exterior.

According to this embodiment, the first detachable attaching part 162 may comprise a steel piece which is mounted to the band member 161 to have the shape of a male button, and the second detachable attaching part 163 may comprise a magnet which has the shape of a female button so that the first detachable attaching part 162 may be detachably attached to the second detachable attaching part.

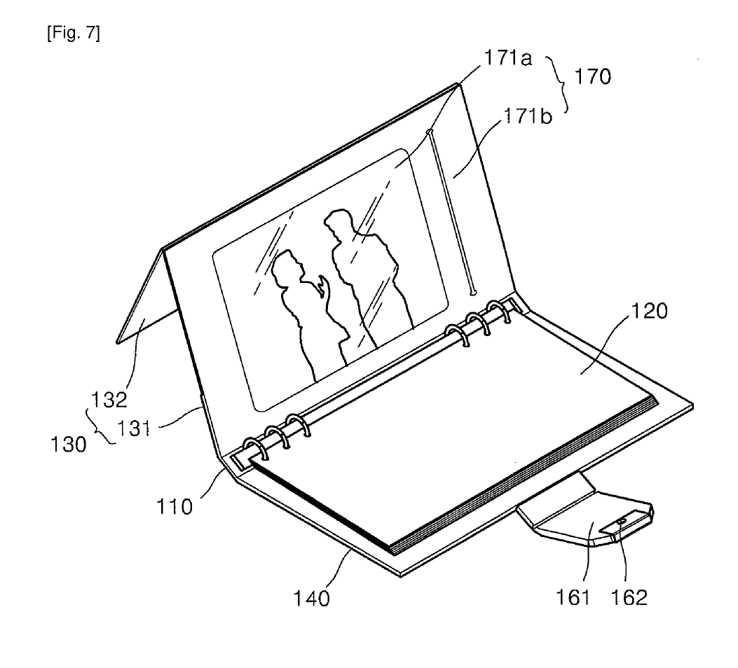

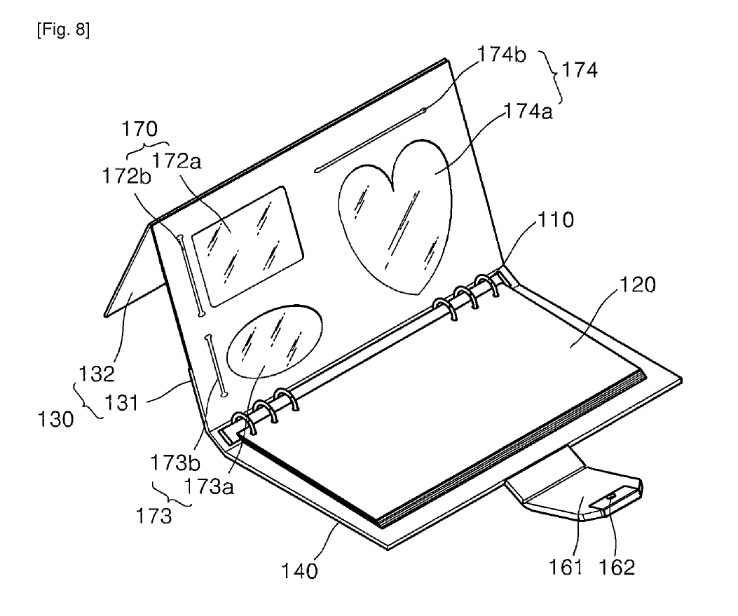

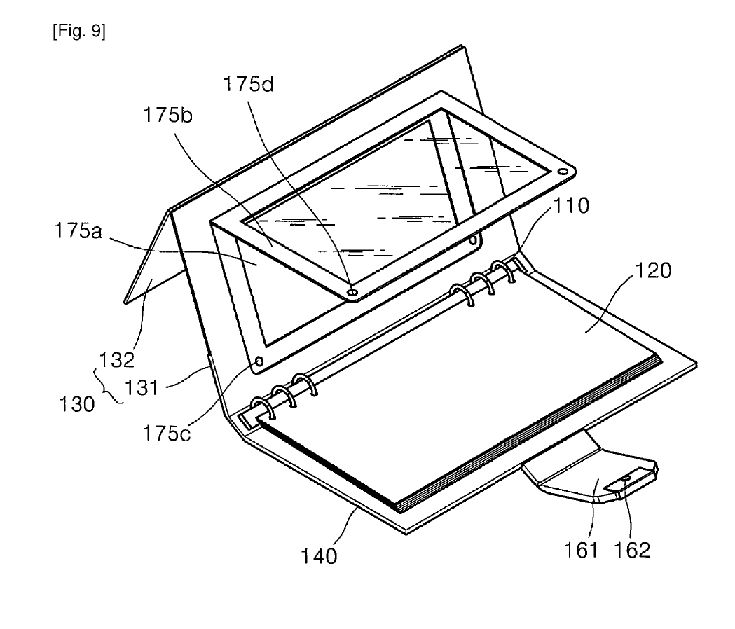

FIG. 7 is a view illustrating a picture mounting part formed in the front cover, FIG. 8 is a view illustrating another embodiment of the picture mounting part of FIG. 7, and FIG. 9 is a view illustrating a further embodiment of the picture mounting part of FIG. 7.

One or more picture mounting parts are provided on the front or back of the main front cover part 131 of the front cover 130 so that a picture may be detachably mounted to the picture mounting part. The picture mounting part allows the picture to be removably mounted to the main front cover part 131, so that the main front cover part 131 serves as an album. As shown in FIG. 7, one picture mounting part 171 may completely cover the main front cover part 131. Alternatively, as shown in FIG. 8, two or more picture mounting parts, for example, a rectangular picture mounting part 172, an elliptical picture mounting part 173, and a heart-shaped picture mounting part 174 may be provided on the main front cover part. Each picture mounting part 171, 172, 173, or 174 includes a window 171a, 172a, 173a, or 174a formed in the main front cover part, and a picture entrance slit 171b, 172b, 173b, or 174b which is formed to a side of the corresponding window so that a picture may be inserted into the main front cover part 131. Here, the window entrance slit may be formed at various positions, including a side of each window or a position under the window.

Meanwhile, as shown in FIG. 9, a picture mounting part 175 includes a picture entrance opening 175a which is formed in the main front cover part 131, and a window 175b which opens or closes the picture entrance opening 175a. The window 175b may be connected to a surface of the picture entrance opening 175a, or be separated from the picture entrance opening 175a. Further, magnetic detachable attaching parts 175c and 175d are installed at the window 175b and the picture entrance opening 175a so that the window 175b is attracted to the picture entrance opening 175a facilitating a closed state. The magnetic detachable attaching parts 175c and 175d may comprise magnets which are detachably attached to each other, or comprise a magnet and a steel piece. According to this embodiment, the magnetic detachable attaching parts comprise magnets 175c which are installed on the main front cover part 131, and steel pieces 175d which are installed at the window 175b.

A page mounting part may be provided on the binder 110, the front cover 130, or the back cover 140, so that a page unit on which various pieces of information are printed or on which a memo can be taken is detachably supported by the page mounting part. The page mounting part may be embodied in various shapes, and several embodiments of the page mounting part will be described below.

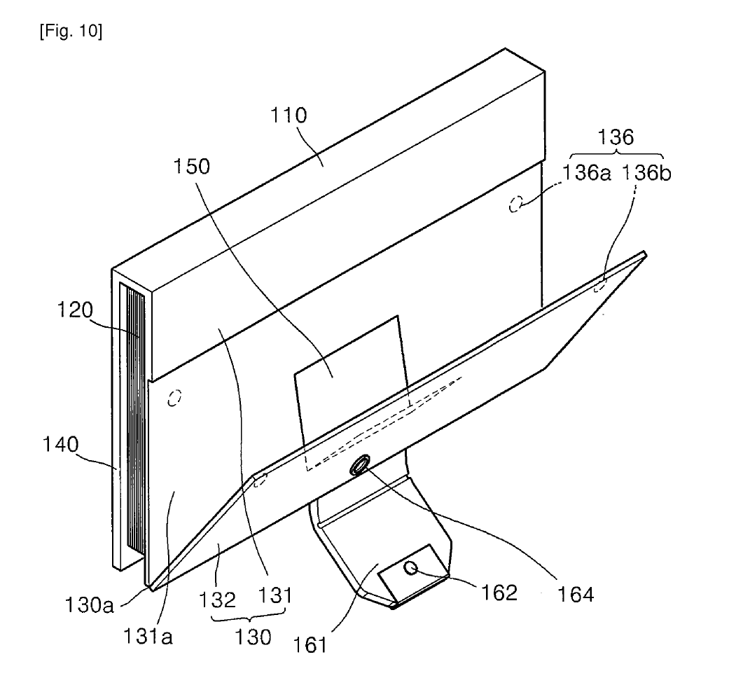

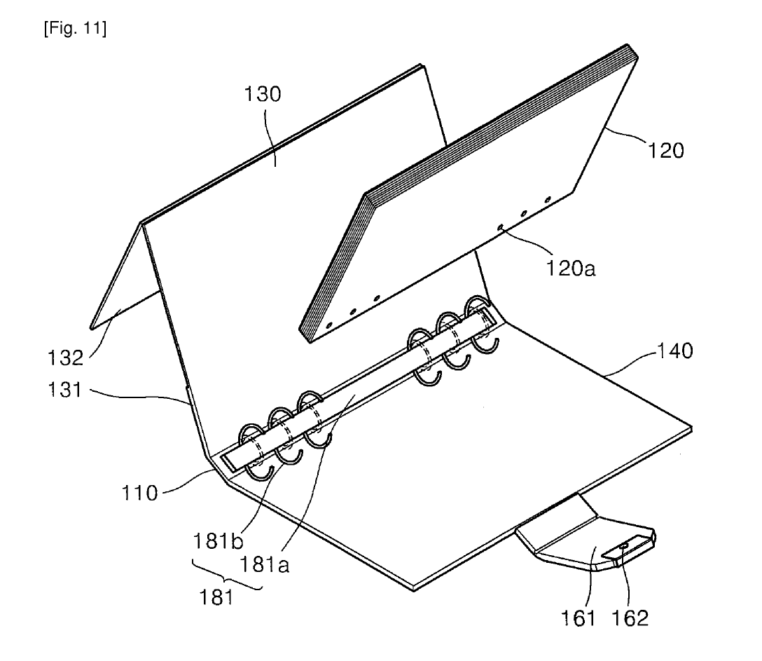

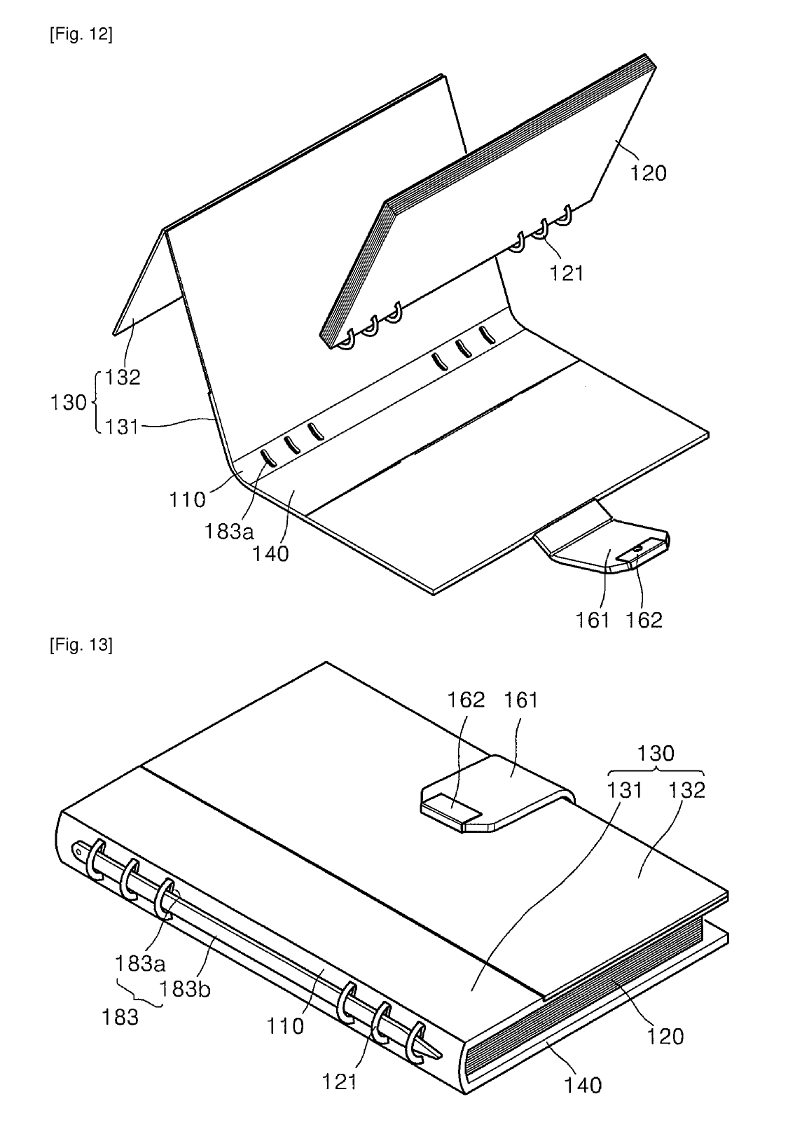

FIG. 10 is a view illustrating a binder which directly connects the front and back covers to each other, FIG. 11 is a view illustrating an embodiment of a page mounting part which mounts pages, and FIGS. 12 and 13 are views illustrating another embodiment of the page mounting part whereby pages are mounted.

According to an embodiment, as shown in FIG. 11, a page mounting part 181 is installed to the binder 110 which directly connects the front cover 130 to the back cover 140. The page mounting part includes a mounting body 181a which is secured to the binder 110, and fastening rings 181b which are installed in the mounting body 181a and are opened or closed by the mounting body 181a. In such a construction, when the fastening rings 181b which are opened or closed by manipulating the mounting body 181a are fitted into fastening holes 120a of the page unit 120, the page unit 120 is detachably mounted to the page mounting part 181. Here, as described above, since the fastening rings 181b, which are opened or closed by manipulating the mounting body 181a, are known to those skilled in the art, the detailed description of the fastening rings will be omitted.

According to another embodiment, as shown in FIGS. 12 and 13, a page mounting part 182 is provided on the binder 110 which directly connects the front cover 130 to the back cover 140. The page mounting part includes a plurality of fitting holes 183a into which subsidiary fastening rings 121 for binding the page unit 120 are fitted, and a support strip 183b which passes through the subsidiary fastening rings 121 protruding from the fitting holes 183a. By such a construction, the subsidiary fastening rings 121 of the page unit are fitted into the corresponding fitting holes 183a, and then the support strip 183b passes through the subsidiary fastening rings 121 which protrude rearwards from the binder 110. Thereby, the page unit 120 can be detachably mounted to the page mounting part 183.

Further, the page mounting part may comprise a plurality of vinyl bags which are provided on the binder 110 and receive a plurality of pieces of paper, or may comprise a pocket which is provided on the inner surface of the front or back cover 130 or 140 so that various information media are inserted into the pockets. As such, the page mounting part may be embodied into various shapes.

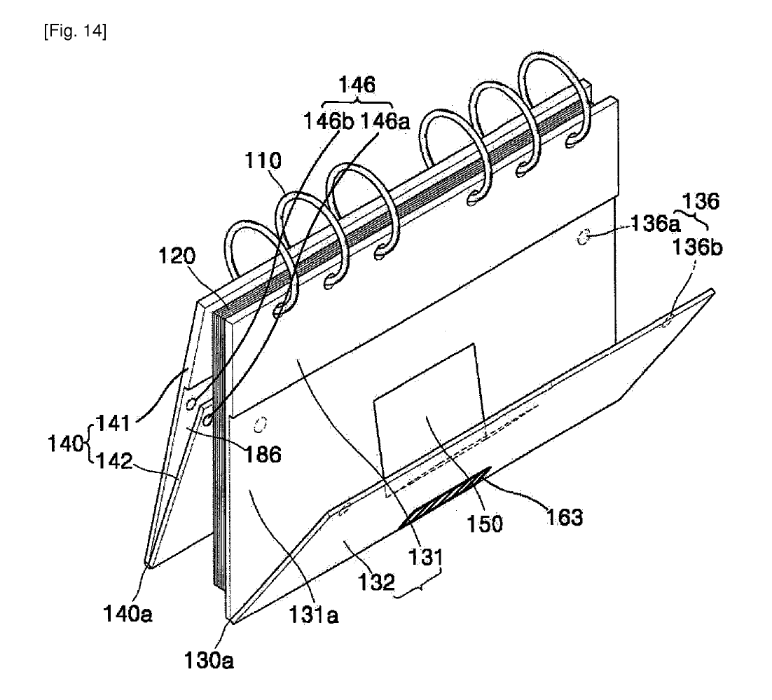

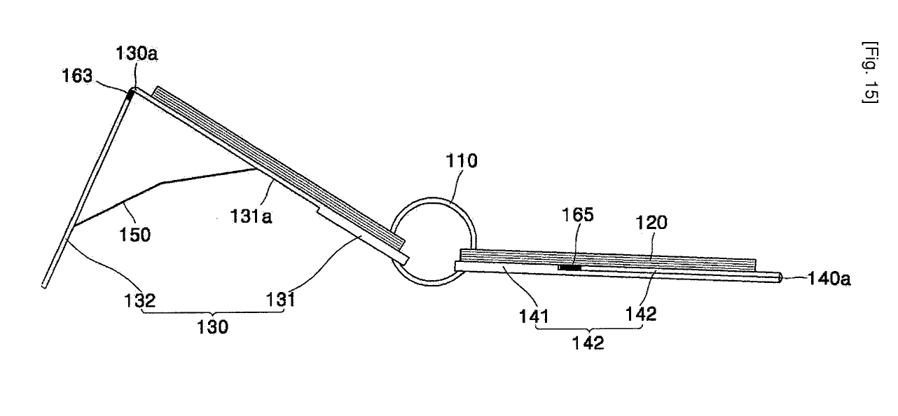

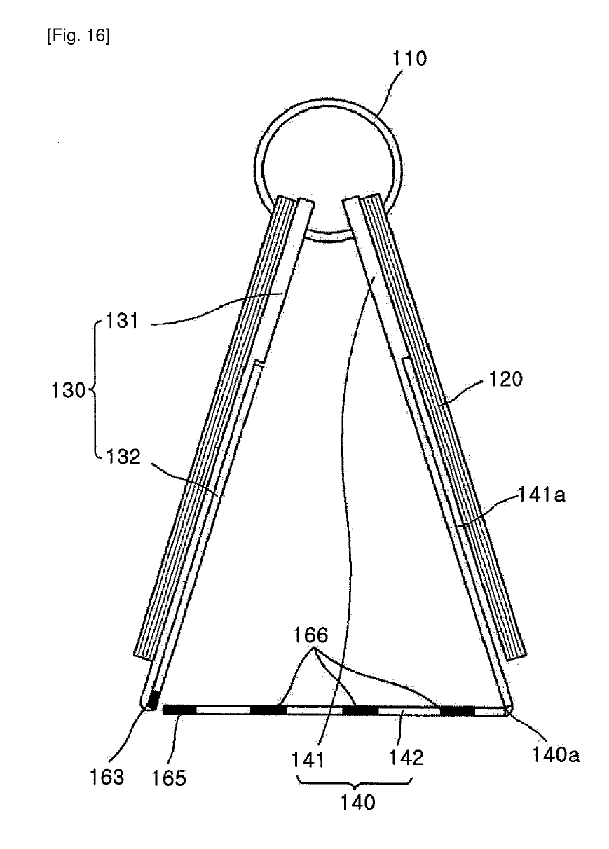

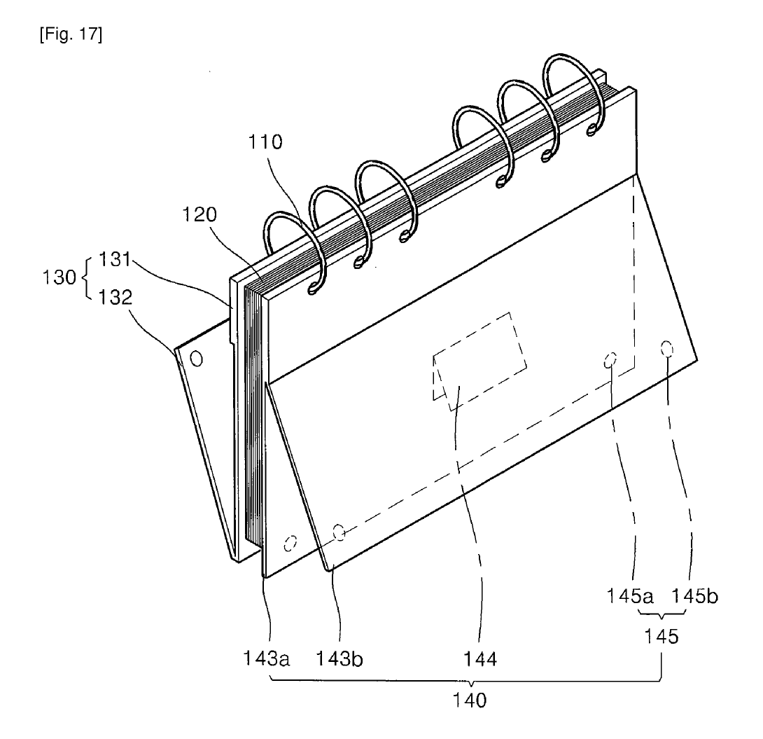

FIG. 14 is a view illustrating a back cover having a main back cover part and a subsidiary back cover part, FIG. 15 is a view illustrating the operation of unfolding the front cover of FIG. 14 relative to the back cover such that the front cover is at an obtuse angle with the back cover, and FIG. 16 is a view illustrating the state in which the front and back covers of FIG. 15 are erected.

As shown in the drawings, the back cover 140 includes a main back cover part 141 and a subsidiary back cover part 142 which are separated from each other by a separation line 140a. A detachable attaching unit 146 is provided between the main back cover part 141 and the subsidiary back cover part 142 to maintain the closed state of the main back cover part 141 and the subsidiary back cover part 142. As in the detachable attaching unit of the front cover, the detachable attaching unit 146 may comprise magnets which are detachably attached to each other, or comprise a magnet and a steel piece. According to this embodiment, the detachable attaching unit 146 includes a magnet 146a which is installed on the main back cover part 141, and a steel piece 146b which is mounted to the subsidiary back cover part 142 to be attached to the magnet 146a. Further, a fourth detachable attaching part 165 is mounted to an end of the subsidiary back cover part 142 to be detachably attached to a second detachable attaching part 163. Here, the second detachable attaching part 163 and the fourth detachable attaching part 165 comprise magnets which are detachably attached to each other, or comprise a magnet and a steel piece. Further, a stepped surface 141a, which is thinner than the main back cover part 141, is horizontally provided on a predetermined portion of the main back cover 141. When the subsidiary back cover part 142 is folded along the separation line 140a, the subsidiary back cover part overlaps the stepped surface 141a. When a user desires to set up the cover of the present invention, which is constructed as described above, as shown in FIG. 16, the subsidiary front cover part 132 overlaps the main front cover part 131, and then the subsidiary back cover part 142 is obliquely folded around the separation line 140a. Afterwards, the fourth detachable attaching part 165 of the subsidiary back cover part 142 is attached to the first detachable attaching part 163. In this case, when seeing the side of the cover, the cover is erected forming a triangular shape.

Further, fifth detachable attaching parts 166 may be installed to the subsidiary back cover part 142 so that the second detachable attaching part 163, provided around the separation line 130a of the main front cover part 131, is detachably attached to the fifth detachable attaching part. In order to detachably attach the fifth detachable attaching parts 166 to the second detachable attaching part 163, the attachment mechanism may comprise Velcro fasteners, or a magnet and a steel piece which are magnetically attracted to each other, or comprise magnets which are arranged such that opposite polarities thereof face each other. Thus, as the second detachable attaching part 163 is attached to a fifth detachable attaching part 166 provided at a specific position, the erection angle of the cover can be changed.

Hereinafter, the operation of the cover capable of supporting multi-purpose contents will be described.

When a user desires to carry the cover, as shown in FIG. 2, the subsidiary front cover part 132 is folded along the separation line 130a to overlap the stepped surface 131a of the main front cover part 131. At this time, the magnet 136a, installed at the main front cover part 131, is attached to the steel piece 136b installed at the subsidiary front cover part 132, so that the subsidiary front cover part 132 overlaps the main front cover part 131. In such a state, the band member 161 is bent so that the first detachable attaching part 162 is attached to the third detachable attaching part 164.

Meanwhile, when a user desires to set up the cover, as shown in FIG. 3, the front and back covers 130 and 140 stand obliquely relative to the binder 110. The band member 161 is unfolded, so that the first detachable attaching part 162 is attached to the second detachable attaching part 163. In this case, when viewed from the side of the cover, the cover has a triangular shape.

The cover capable of supporting multi-purpose contents of the present invention may be arranged, as shown in FIG. 4. That is, after the front cover 130 is unfolded to be at an obtuse angle with the back cover 140, the subsidiary front cover part 132 is unfolded backwards along the separation line 130a. At this time, the angle holding unit 150 between the subsidiary front cover part 132 and the main front cover part 131 becomes flat, so that the main front cover part 131 maintains the oblique angle. In such a state, a part of the page unit 120 leans on the main front cover part 131, and the remaining part of the page unit leans on the back cover 140. Thus, a user can see both the part of the page unit leaning on the main front cover part 131 and the part of the page unit leaning on the back cover 140.

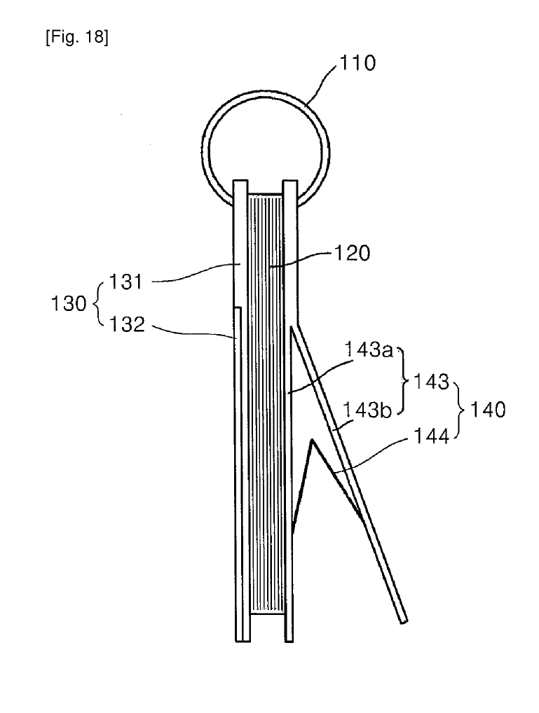

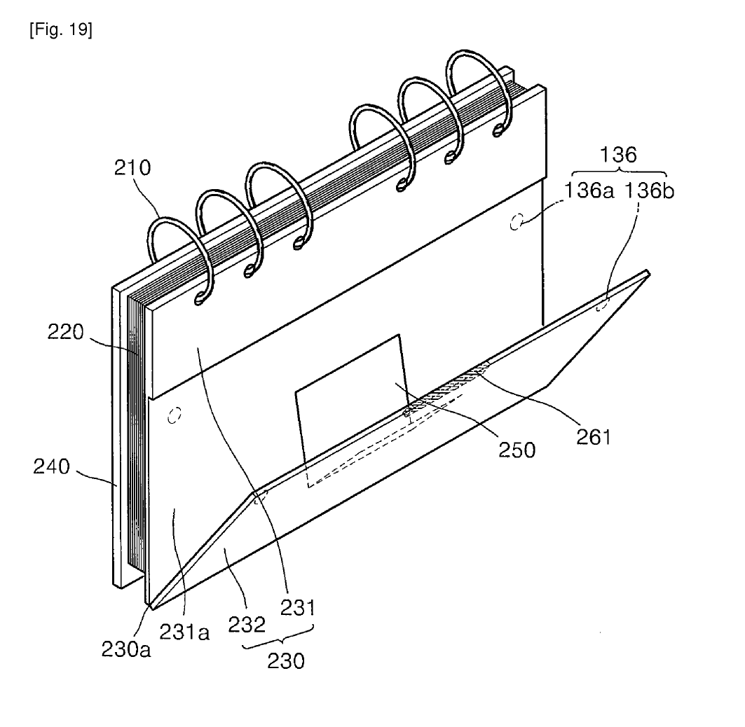

FIG. 17 is a view illustrating a back cover having a main back cover part and a subsidiary back cover part, and FIG. 18 is a view illustrating the state in which the back cover of FIG. 17 is rotated outwards to be erected.

As shown in the drawings, the back cover 140 includes a main back cover part 143a and a subsidiary back cover part 143b which are connected at upper ends thereof, such that they overlap with each other. A subsidiary angle holding unit 144 is provided between the main back cover part 143a and the subsidiary back cover part 143b to maintain an angle between the main back cover part 143a and the subsidiary back cover part 143b. Further, a subsidiary detachable attaching unit 145 is provided on the main front cover part 143a and the subsidiary front cover part 143b to maintain the overlapping state of the main front cover part 143a and the subsidiary front cover part 143b.

As described above, the subsidiary detachable attaching unit 145 may comprise magnets which are detachably attached to each other, or comprise a magnet and a steel piece. According to this embodiment, the subsidiary detachable attaching unit 145 includes a magnet 145a which is provided on the main back cover part 143a, and a steel piece 145b which is provided on the subsidiary back cover part 143b, attachable to the magnet 145a.

When a user desires to set up the cover constructed as described above, as shown in FIG. 18, the subsidiary back cover part 143b is opened away from the main back cover part 143a. When this state is viewed from the side of the cover, the cover has a triangular shape.

Next, a cover capable of supporting multi-purpose contents according to the second embodiment of the present invention will be described.

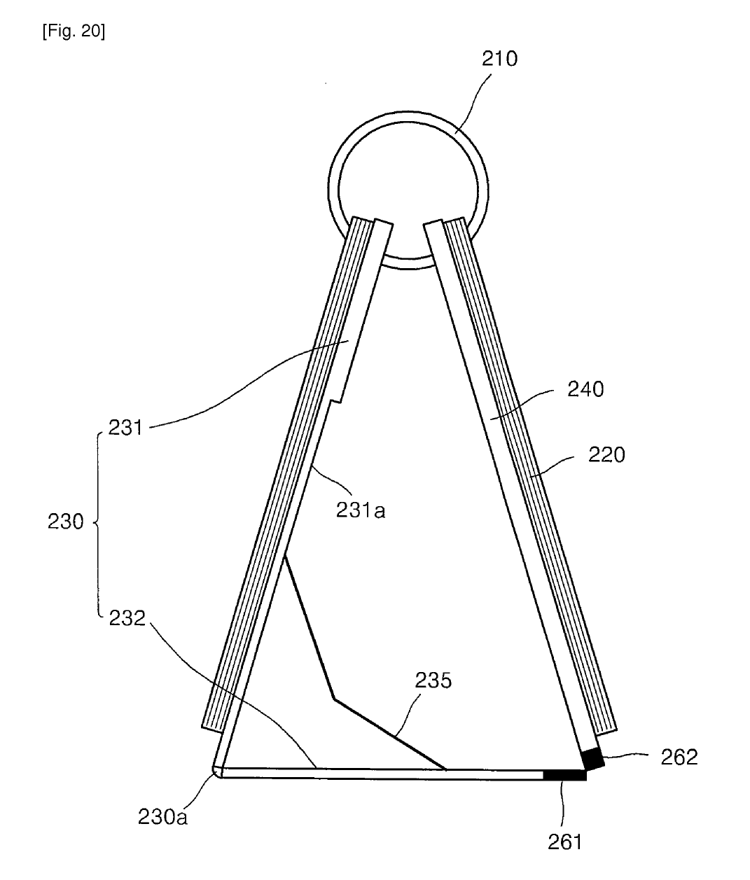

FIG. 19 is a view illustrating a cover capable of supporting multi-purpose contents according to the second embodiment of the present invention, and FIG. 20 is a view illustrating the state in which the front and back covers of FIG. 19 are in an erected state.

As shown in the drawings, the cover capable of supporting multi-purpose contents according to the second embodiment of the present invention includes a front cover 230 and a back cover 240 which are superposed on the front and back of a page unit 220 and are bound together by a binder 210. The front cover 230 includes a main front cover part 231 and a subsidiary front cover part 232 which are separated from each other by a separation line 230a. An angle holding unit 250 is provided between the main front cover part 231 and the subsidiary front cover part 232 to hold an angle between the main front cover part 231 and the subsidiary front cover part 232. A first detachable attaching part 261 is provided on an edge of the subsidiary front cover part 232, and a second detachable attaching part 262 is provided on an edge of the back cover 240 to be attached to the first detachable attaching part 261.

Since the binder 210, the page unit 220, the angle holding unit 250, and the detachable attaching part 236 are equivalent to the binder 110, the page unit 120, the angle holding unit 150, and the detachable attaching part 236 of the cover according to the first embodiment, they will not be described herein.

The first and second detachable attaching parts 261 and 262 may be embedded in the subsidiary front cover part 232 and the back cover 240, and may be installed together with various decorations to be exposed to the outside. If one of the first and second detachable attaching parts 261 and 262 is a magnet, the other is a steel piece. Further, the first and second detachable attaching parts may comprise magnets of opposite poles, a button or a long bar, or Velcro fasteners. When a user desires to set up the cover constructed as described above, as shown in FIG. 20, the subsidiary front cover part 232 is unfolded obliquely along the separation line 230a, and then the first detachable attaching part 261 of the subsidiary front cover part 232 is attached to the second detachable attaching part 262 of the back cover 240. In this case, when the cover is viewed from the side, the cover has a triangular shape.

A page mounting part of the cover capable of supporting multi-purpose contents according to the first embodiment may be mounted to the binder 210, the front cover 230, or the back cover 240. The page mounting part supports the page unit on which various pieces of information are printed or on which a memo may be taken.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A cover capable of supporting multi-purpose contents, which has a front cover and a back cover which are superposed on front and back surfaces of a page unit and are bound by a binder, wherein the front cover comprises a main front cover part and a subsidiary front cover part which are separated from each other by a separation line, and an angle holding unit is provided between the main front cover part and the subsidiary front cover part to maintain an angle between the main front cover part and the subsidiary front cover part.

2. The cover capable of supporting multi-purpose contents according to claim 1, further comprising:
a position holding unit provided between the front cover and the back cover to hold the front and back covers in a folded or erected position.

3. The cover capable of supporting multi-purpose contents according to claim 1, wherein a stepped surface, which is thinner than the main front cover part, is horizontally formed on the main front cover part, the subsidiary front cover part is folded along the separation line to overlap the stepped surface, and a detachable attaching unit is provided between the main front cover part and the subsidiary front cover part to maintain an overlapping state of the main front cover part with the subsidiary front cover part.

4. The cover capable of supporting multi-purpose contents according to claim 1, wherein the angle holding unit comprises a band which is foldably installed between the main front cover part and the subsidiary front cover part.

5. The cover capable of supporting multi-purpose contents according to claim 1, wherein the angle holding unit is foldably connected to a lower edge of the front cover, and comprises a plurality of support protrusions which support an edge of the subsidiary front cover part when the front cover is unfolded, and which are fitted into protrusion insert holes of the main front cover part when the front cover is closed and folded.

6. The cover capable of supporting multi-purpose contents according to claim 2, wherein the position holding unit comprises:
a band member installed at either of the front cover and the back cover;
a first detachable attaching part installed at the band member;
a second detachable attaching part installed at a complementary remaining front or back cover to be detachably attached to the first detachable attaching part; and
a third detachable attaching part installed above the second detachable attaching part to be detachably attached to the first detachable attaching part.

7. The cover capable of supporting multi-purpose contents according to claim 1, further comprising:
at least one picture mounting part provided in the main front cover part of the front cover so that a picture is detachably mounted to the picture mounting part, the picture mounting part comprising:
a window formed in the main front cover part; and
a picture entrance slit formed on a side of the window so that the picture enters the main front cover part through the picture entrance slit.

8. The cover capable of supporting multi-purpose contents according to claim 1, further comprising:
at least one picture mounting part provided in the main front cover part of the front cover so that a picture is detachably mounted to the picture mounting part, the picture mounting part comprising:
a picture entrance opening formed in a surface of the main front cover part;
a window for opening or closing the picture entrance opening; and
magnetic detachable attaching parts installed, respectively, at the window and the picture entrance opening, thus maintaining overlapping state of the window with the picture entrance opening.

9. The cover capable of supporting multi-purpose contents according to claim 1, further comprising:
a page mounting part installed at the binder or the front cover or the back cover, thus detachably supporting the page unit on which various pieces of information are printed or on which a memo may be taken.

10. The cover capable of supporting multi-purpose contents according to claim 9, wherein the page mounting part is provided on the binder which directly connects the front cover to the back cover, and comprises a plurality of fitting holes into which subsidiary fastening rings for binding the page unit are fitted, and a support strip which passes through the subsidiary fastening rings protruding from the fitting holes.

11. The cover capable of supporting multi-purpose contents according to claim 1, wherein the back cover comprises a main back cover part and a subsidiary back cover part which are separated from each other by a separation line, and further comprising:
a detachable attaching unit installed between the main back cover part and the subsidiary back cover part to maintain an overlapping closed state of the main back cover part and the subsidiary back cover part.

12. The cover capable of supporting multi-purpose contents according to claim 11, wherein a predetermined section of the main back cover part is horizontally stepped, thus forming a stepped surface which is thinner than the main back cover part, and the subsidiary back cover part is folded along the separation line to overlap the stepped surface.

13. The cover capable of supporting multi-purpose contents according to claim 11, wherein a fifth detachable attaching part is installed at the subsidiary back cover part so that the second detachable attaching part installed around the separation line of the main front cover part is detachably attached to the fifth detachable attaching part.

14. The cover capable of supporting multi-purpose contents according to claim 1, wherein the back cover comprises a main back cover part and a subsidiary back cover part which are connected at upper ends thereof to each other such that they overlap each other,
a subsidiary angle holding unit is further provided between the main back cover part and the subsidiary back cover part, thus supporting an angle between the main back cover part and the subsidiary back cover part, and
a subsidiary detachable attaching unit is further installed on the main front cover part and the subsidiary front cover part, thus maintaining an overlapping state of the main front cover part and the subsidiary front cover part.

15. A cover capable of supporting multi-purpose contents having a front cover and a back cover which are superposed on front and back surfaces of a page unit and are bound by a binder, wherein
the front cover comprises a main front cover part and a subsidiary front cover part which are separated from each other by a separation line,
an angle holding unit is connected between the main front cover part and the subsidiary front cover part to hold an angle between the main front cover part and the subsidiary front cover part,
a first detachable attaching part is installed at an edge of the subsidiary front cover part, and
a second detachable attaching part is installed at an edge of the back cover so as to be attachable to the first detachable attaching part.

16. The cover capable of supporting multi-purpose contents according to claim 14, further comprising:
a page mounting part installed at the binder or the front cover or the back cover, thus detachably supporting the page unit on which various pieces of information are printed or on which a memo may be taken.

17. The cover capable of supporting multi-purpose contents according to claim 2, wherein a stepped surface, which is thinner than the main front cover part, is horizontally formed on the main front cover part, the subsidiary front cover part is folded along the separation line to overlap the stepped surface, and a detachable attaching unit is provided between the main front cover part and the subsidiary front cover part to maintain an overlapping state of the main front cover part with the subsidiary front cover part.

18. The cover capable of supporting multi-purpose contents according to claim 2, wherein the angle holding unit comprises a band which is foldably installed between the main front cover part and the subsidiary front cover part.

19. The cover capable of supporting multi-purpose contents according to claim 2, wherein the angle holding unit is foldably connected to a lower edge of the front cover, and comprises a plurality of support protrusions which support an edge of the subsidiary front cover part when the front cover is unfolded, and which are fitted into protrusion insert holes of the main front cover part when the front cover is closed and folded.

20. The cover capable of supporting multi-purpose contents according to claim 2, further comprising:
at least one picture mounting part provided in the main front cover part of the front cover so that a picture is detachably mounted to the picture mounting part, the picture mounting part comprising:
a window formed in the main front cover part; and
a picture entrance slit formed on a side of the window so that the picture enters the main front cover part through the picture entrance slit.

21. The cover capable of supporting multi-purpose contents according to claim 2, further comprising:
at least one picture mounting part provided in the main front cover part of the front cover so that a picture is detachably mounted to the picture mounting part, the picture mounting part comprising:
a picture entrance opening formed in a surface of the main front cover part;
a window for opening or closing the picture entrance opening; and
magnetic detachable attaching parts installed, respectively, at the window and the picture entrance opening, thus maintaining overlapping state of the window with the picture entrance opening.

22. The cover capable of supporting multi-purpose contents according to claim 2, further comprising:
a page mounting part installed at the binder or the front cover or the back cover, thus detachably supporting the page unit on which various pieces of information are printed or on which a memo may be taken.
